(19) United States
(12) Patent Application Publication
(10) Pub. No.: US 2003/0120617 A1
(43) Pub. Date: Jun. 26, 2003

(54) POSTAGE METERING SYSTEM EMPLOYING POSITIONAL INFORMATION

(75) Inventor: JP LEON, SAN CARLOS, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LEROY RODNEY C

(21) Appl. No.: 09/359,163

(22) Filed: Jul. 21, 1999

Related U.S. Application Data
(63) Continuation of application No. 09/250,990, filed on Feb. 16, 1999, now Pat. No. 6,424,954.
(60) Provisional application No. 60/094,127, filed on Jul. 24, 1998.
(60) Provisional application No. 60/093,849, filed on Jul. 22, 1998.
(60) Provisional application No. 60/094,065, filed on Jul. 24, 1998.
(60) Provisional application No. 60/094,073, filed on Jul. 24, 1998.
(60) Provisional application No. 60/094,116, filed on Jul. 24, 1998.
(60) Provisional application No. 60/094,120, filed on Jul. 24, 1998.
(60) Provisional application No. 60/094,122, filed on Jul. 24, 1998.

(51) Int. Cl. G06F 17/00

(52) U.S. Cl. 705/410; 705/402

(57) ABSTRACT

A postage metering device that includes a processor coupled to a memory and a receiver. The memory holds data indicative of a designated geographic area. The receiver receives and processes signals from a number of transmitting sources to provide an estimate of a position of the metering device. The processor receives data from the memory and the estimated position from the receiver and determines whether the metering device is located within the designated geographic area. The processor can initiate a responsive action based on the estimated position of the metering device. The responsive action can include disabling the entire metering device, disabling a set of operations of the metering device, making a call to the service center, and other actions. The positional estimation can be initiated by the metering device, the service center, or other entities. The transmitting sources can be Global Position System (GPS) satellites, cellular base stations, or other systems.

### CROSS-REFERENCES TO RELATED APPLICATIONS

This application claims priority from the following U.S. provisional and non-provisional applications, the disclosures of which, including software appendices and all attached documents, are incorporated by reference in their entirety for all purposes:

Application Serial No. 60/093,849, entitled “Method and Apparatus for Postage Label Authentication,” filed Jul. 22, 1998, of J P Leon and David A. Coolidge;

Application Serial No. 60/094,065, entitled “Method and Apparatus for Resetting Postage Meter,” filed Jul. 24, 1998, of J P Leon;

Application Serial No. 60/094,073, entitled “Method, Apparatus, and Code for Maintaining Secure Postage Information,” filed Jul. 24, 1998, of J P Leon, Albert L. Pion, and Elizabeth A. Simon;

Application Serial No. 60/094,116, entitled “Method and Apparatus for Dockable Secure Metering Device,” filed Jul. 24, 1998, of J P Leon;

Application Serial No. 60/094,120, entitled “Method and Apparatus for Remotely Printing Postage Indicia,” filed Jul. 24, 1998, of Chandrakant J. Shah, J P Leon, and David A. Coolidge;

Application Serial No. 60/094,122, entitled “Postage Metering System Employing Positional Information,” filed Jul. 24, 1998, of J P Leon;

Application Serial No. 60/094,127, entitled “Method and Apparatus for Operating a Removable Secure Metering Device,” filed Jul. 24, 1998, of J P Leon; and

application Ser. No. 09/250,990, entitled “Postage Meter System,” filed Feb. 16, 1999, of J P Leon.

The following related patent applications filed on the same day herewith are hereby incorporated by reference in their entirety for all purposes:

U.S. patent application Ser. No. ______ (Attorney Docket No. 6969-159.1), entitled “Method and Apparatus for Operating a Secure Metering Device,” of J P Leon;

U.S. patent application Ser. No. ______ (Attorney Docket No. 6969-160.1), entitled “Method and Apparatus for Postage Label Authentication,” of J P Leon;

U.S. patent application Ser. No. ______ (Attorney Docket No. 6969-161.1), entitled “Method, Apparatus, and Code for Maintaining Secure Postage Data,” of J P Leon, Albert L. Pion, and Elizabeth A. Simon;

U.S. patent application Ser. No. ______ (Attorney Docket No. 6969-163.1), entitled “Method and Apparatus for Resetting Postage Meter,” of J P Leon; and

U.S. patent application Ser. No. ______ (Attorney Docket No. 6969-164.1), entitled “Method and Apparatus for Remotely Printing Postage Indicia,” of Chandrakant J. Shah, J P Leon, and David A. Coolidge.

### BACKGROUND OF THE INVENTION

The present invention relates generally to postage metering systems, and more particularly to a postage metering system employing positional information.

A postage meter allows a user to print postage or other indicia of value on envelopes or other media. The postage meter can be leased or rented from a commercial group (e.g., Neopost). Conventionally, the user purchases a particular amount of value beforehand and the meter is programmed with this amount. Subsequently, the user is allowed to print postage up to the programmed amount. Some modem postage meters allow the user to purchase additional amounts via a communications link (e.g., a telephone modem or the Internet).

Because a postage meter is capable of printing postage having a value, security is critical to prevent unauthorized use. Traditionally, meter security is provided by mechanical arrangements and/or electronic control circuitry that direct the operation of a print mechanism within the meter. With the advent of electronic control circuitry, meter security is typically provided by digital signature, encryption, and other techniques. These techniques allow for electronic detection of meter tampering, e.g., attempts to modify the normal operation of the accounting registers used to store value.

Another conventional technique for providing meter security utilizes a system of tracking and inspection. This technique typically relies on traditional business methods built around service records, log books, lease documents, and other records. By periodically inspecting the records, the postal authorities and meter companies can attempt to maintain control of the meters and ascertain their whereabouts at all times.

Some of these security techniques are marginally effective in deterring and preventing fraud. For example, the tracking and record inspection technique is susceptible to intentional fraud and unintended human errors. This results in many postage meters disappearing each year, with many being diverted to fraudulent use.

### SUMMARY OF THE INVENTION

The invention provides a postage metering system that includes a metering device and employs positional information. Generally, the position of the metering device can be estimated by using a Global Position System (GPS) receiver, a cellular receiver, a terrestrial receiver, or other receivers. In an embodiment, the metering device is authorized to operate in a designated geographic area. The estimated position of the metering device is then compared against the designated geographic area and appropriate actions can be initiated if the metering device is located outside this area. In other embodiment, the whereabouts of the metering device can be updated periodically, or as necessary, using the positional information.

An embodiment of the invention provides a postage metering device that includes a processor coupled to a memory and a receiver. The memory holds data indicative of a designated geographic area. The receiver receives and processes signals from a number of transmitting sources to provide an estimate of a position of the metering device. The processor receives data from the memory and the estimated position from the receiver and determines whether the metering device is located within the designated geographic area.

The processor can initiate a responsive action based on the estimated position of the metering device. The responsive action can include disabling the entire metering device, disabling a set of operations of the metering device, making a call to the service center, and other actions. The positional estimation can be initiated by the metering device, the service center, or other entities. The transmitting sources can be Global Position System (GPS) satellites, cellular base stations, or other systems.

Another embodiment of the invention provides a metering device that includes a receiver coupled to a processor. The receiver receives and processes signals from a number of GPS satellites to provide positional information indicative of an estimated position of the metering device. The processor receives the positional information and initiates a responsive action based on the received positional information. Various features described above can also be applied to this embodiment.

Yet another embodiment of the invention relates to a method for providing security using positional information. The method is applicable to a postage metering system that includes a metering device. In accordance with the method, a designated geographic area for the metering device is initially determined. Signals from a number of transmitting sources are received and processed by the metering device to provide an estimate of a position of the metering device. A determination is then made whether the estimated position of the metering device is within the designated geographic area. A responsive action is initiated based on the estimated position of the metering device. Again, various features described above can also be applied to this embodiment.

Yet another embodiment of the invention relates to a method for providing functions, in a postage metering system, based on positional information. Initially, signals from a plurality of Global Position System (GPS) satellites are received at a metering device. The received signals are processed to provide positional information indicative of an estimated position of the metering device. An action responsive to the positional information is then initiated.

The invention further provide codes that assist in implementation of the embodiments described above.

The foregoing, together with other aspects of this invention, will become more apparent when referring to the following specification, claims, and accompanying drawings.

### BRIEF DESCRIPTION OF THE DRAWINGS

FIGS. 1A through 1C show diagrams of three embodiments of a postage metering system;

FIG. 1D shows a diagram of two embodiments of a remote postage printing systems;

FIG. 2A shows a block diagram of a specific embodiment of a metering device;

FIG. 2B shows a block diagram of an embodiment of a host PC;

FIG. 3 shows a block diagram of an embodiment of a receiver that can be used to estimate the position of a device; and

FIG. 4 shows a flow diagram of an embodiment of a postage metering process that employs positional information.

### DESCRIPTION OF THE SPECIFIC EMBODIMENTS

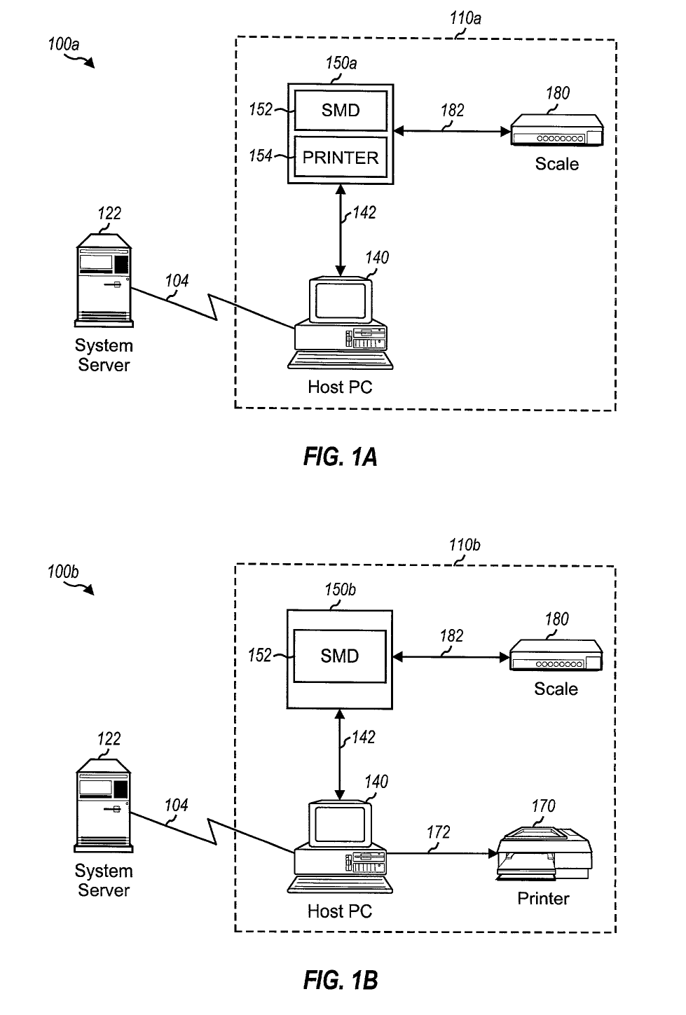

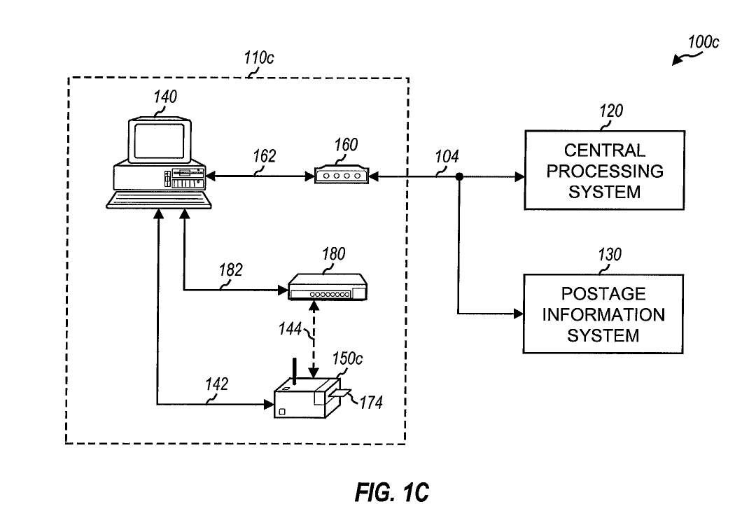

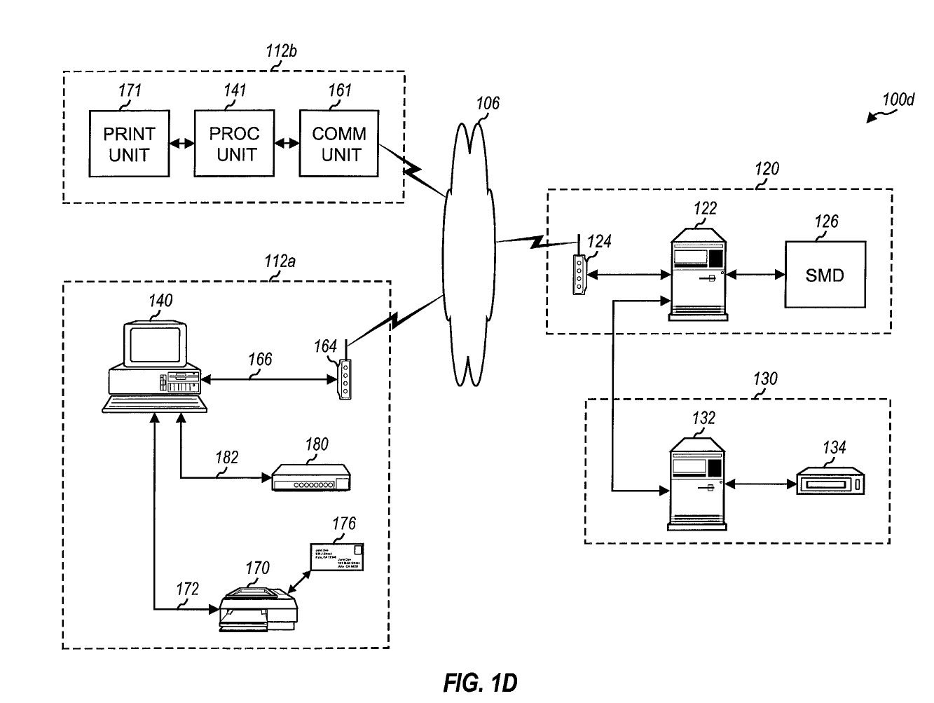

FIG. 1A shows a diagram of an embodiment of a postal system 100a. Postal system 100a includes a postage metering system 110a coupled to a system server 122. Metering system 110a includes a postage metering device 150a coupled to a host personal computer (host PC) 140 via a communications link 142. Host PC further couples to system server 122 (also referred to as a Postage-On-Call™ system or POC system in a specific implementation) via a communications link 104. Metering device 150a can further couple to an optional scale 180, or other peripheral devices, via a communications link 182. In this embodiment, metering device 150a includes a secure metering device (SMD) 152 and a printer 154. The operation of each element in postal system 100a is further described in the aforementioned application Ser. No. 09/250,990.

FIG. 1B shows a diagram of an embodiment of another postal system 100b. Postal system 100b is similar to postal system 100a in FIG. 1A, and includes a postage metering system 110b coupled to system server 122. Metering system 110b includes a postage metering device 150b coupled to host PC 140 via communications link 142 and to optional scale 180 via communications link 182. Host PC 140 further couples to system server 122 via communications link 104 and to a printer 170 via a communications link 172. In this embodiment, metering device 150b includes SMD 152 but no printer.

FIG. 1C shows a diagram of an embodiment of yet another postal system 100c. Postal system 100c includes a postage metering system 110c coupled to a central processing system 120 and a postal information system 130. Metering system 110c includes a postage metering device 150c coupled to host PC 140 via communications link 142. Host PC 140 further couples to a communications device 160 (e.g., a modem, a transceiver, or others) via a communications link 162 and to optional scale 180 via communications link 182. Metering device 150c can also (optionally) couple directly to scale 180 via a communications link 144. Similar to metering device 150a, metering device 150c includes a built-in printer that facilitates the printing of postage indicia on labels and envelopes (as exemplified by an indicium label 174).

Through communications device 160, host PC 140 is able to communicate with central processing system 120 and postage information system 130. Host PC 140 and metering device 150 communicate postage information (e.g., registration, funding, and auditing information) with system server 122, which is part of central processing system 120. Postal information system 130 is a commercially available system that provides access to national (and possibly international) postal information such as ZIP codes, rate tables, and others. Host PC 140 and metering device 150 may communicate with postage information server 130 (i.e., to obtain ZIP code and other information).

FIG. 1D shows a diagram of an embodiment of a postal system 100d that includes two embodiments of remote postage printing systems 112. Postal printing systems 112a and 112b perform the postage printing functions associated with conventional postage meters, and each system can be designed as a stationary system, a portable system, or even a hand-held system. Postage printing system 112 is similar to postage metering system 110, but does not include the SMD.

As shown in FIG. 1D, postage printing system 112a includes host PC 140 that couples to a wireless communications device 164, printer 170, and (optional) electronic scale 180 via communications links 166, 172, and 182, respectively. Postage printing system 112b includes a processing (PROC) unit 141 that couples to a wireless communications (COMM) unit 161 and a print unit 171. Although not shown in FIG. 1D, system 112b typically includes a user interface unit coupled to processing unit 141. System 112b is enclosed in a housing for convenient handling and ease of relocation. System 112b can also be designed as a hand-held unit.

Systems 112 are part of a postal system that further includes a central processing system 120 and (optional) postal information system 130. Systems 112 and 120 communicate via a wireless communications link 106 that can be a cellular, terrestrial, satellite, RF, infrared, microwave, or other links. Central processing system 120 includes a central computer 122 coupled to a wireless communications device 124 and a SMD 126. The combination of SMD 126 with central computer 122 forms a central SMD (CSMD) that facilitates and enables remote printing of postage over a wireless link. This wireless postal system is further described in the aforementioned U.S. patent application Ser. No. ______ (Attorney Docket No. 6969-164.1).

Postal information system 130 is a commercially available system, with approximately 150 or more installations in the United States, that provides access to national (and possibly international) postal information such as ZIP codes, and other information. Postal information system 130 includes a system server 132 that couples to a storage unit 134 and central processing system 130. Storage unit 134 stores a database of postal information, such as national and international postal ZIP code information and so on. Storage unit 134 can be implemented with a CD-ROM device, a tape drive, a hard disk, other mass storage devices, or a combination of these devices. Various systems, including systems 110 and 112, can obtain information from postal information system 130 (possibly via central processing system 130). The operation of postal information system 130 is well known in the art and not described in detail herein.

Postage metering systems 110a through 110c and postage printing systems 112a and 112b are examples of systems capable of printing postage indicia. Other systems can also be designed to print indicia and are within the scope of the invention.

In FIGS. 1A through 1D, the communications links (e.g., links 142, 144, 162, 166, 172, and 182) between the host PC and peripheral equipment can be wireline or wireless links. For example, these links can be standard serial or parallel interfaces and may employ any mechanism for transferring information, such as RS-232C serial communications link. These links can also be infrared links. The communications link between the postage metering/printing systems and other systems can also be a wireline link (e.g., telephone, Internet, cable, and others), a wireless link (e.g., terrestrial, satellite, microwave, infrared, and others), or other links. To provide a secure communications link that resists unauthorized interception, data can be encrypted, encoded, or signed before being sent over the link.

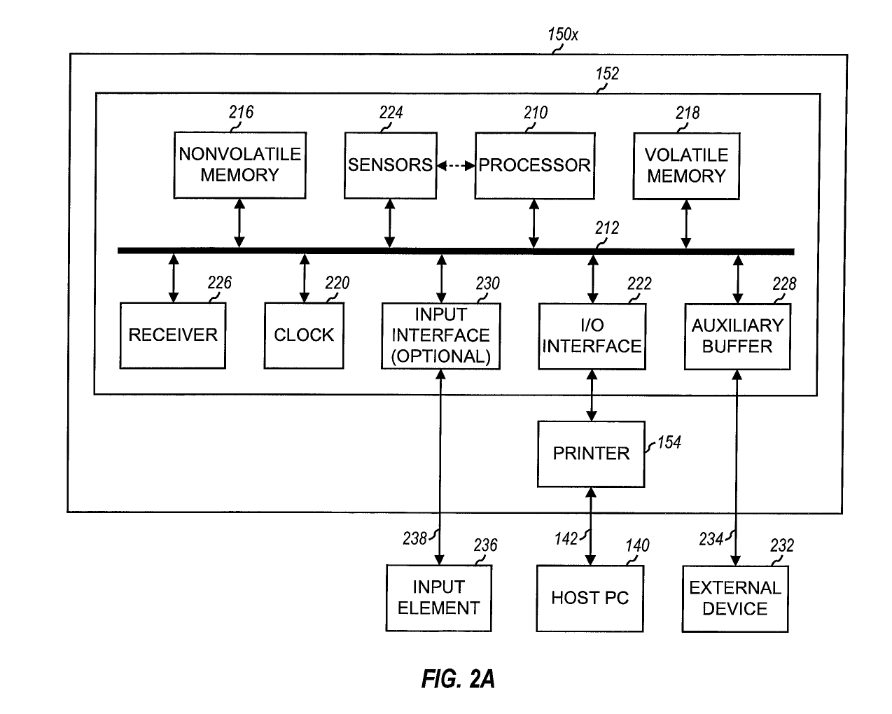

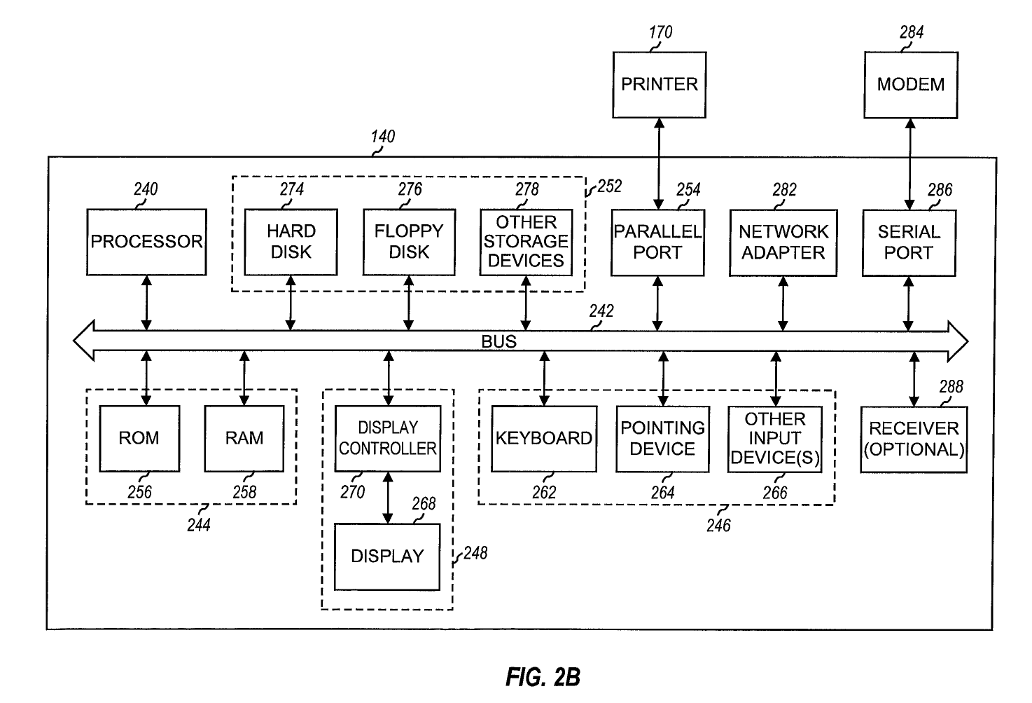

FIG. 2A shows a block diagram of a specific embodiment of metering device 150x. Metering device 150x can be used with any of the systems shown in FIGS. 1A through 1C. In some embodiments, metering device 150x is implemented as a dockable or removable device, or both, that attaches to a docking station. Dockable and removable metering devices are described in the aforementioned U.S. patent application Ser. No. ______ (Attorney Docket No. 6969-159.1).

Metering device 150x includes SMD 152 and printer 154. In the specific embodiment shown in FIG. 2A, within SMD 152, a processor 210 couples to a bus 212 that also interconnects a non-volatile memory 216, a volatile memory 218, a clock 220, an I/O interface 222, sensors 224, a receiver 226, an auxiliary buffer 228, and an (optional) input interface 230. Auxiliary buffer 228 supports an auxiliary port that couples to an external device 232 (e.g., an electronic scale) via a communications link 234. Auxiliary buffer 228, when enabled, receives and stores data from external device 232. Input interface 230 couples to an input element 236 (e.g., a keypad, buttons, and so on) via a communications link 238.

Processor 210 performs data processing and coordinates communication with the host PC. In an embodiment, processor 210 also performs the secure processing functions for the metering device. Non-volatile memory 216 stores data and codes used by the metering device, such as accounting information and operational information that defines and describes the operation of the metering device. Volatile memory 218 stores data and program instructions. Clock 220 provides indication of current time when requested by the processor.

Sensors 224 can be dispersed throughout metering device 150x to detect tampering with the device and to report such event to processor 210. Sensors 224 can couple directly to processor 210, or to bus 212, or a combination of both. Receiver 226 is used to provide positional information, as described below.

I/O interface 222 couples to printer 154 (for embodiments that include a built-in printer) and further to host PC 140 via communications link 142. In an embodiment, link 142 is a standard interface such as RS-232. I/O interface 222 can be designed to operate on a command set written to reject external print commands, as described in the aforementioned U.S. patent application Ser. No. 09/250,990.

In an embodiment, the SMD is responsible for maintaining the contents of certain security relevant data items (SRDIs). The SRDIs can include revenue or accounting registers, cryptographic keys used for secure data transfer, operational data, and others. In an embodiment, the SMD comprises a cryptographic module that performs the secure processing required by the postage metering system. In an embodiment, the cryptographic module includes processor 210, memories 216 and 218, clock 220, I/O interface 222, and buffer 228. In a specific embodiment, for enhanced security, the cryptographic module is enclosed in a tamper-evident and/or tamper-resistant enclosure, and physical access to elements in the cryptographic module is possible only upon destruction of the enclosure.

FIG. 2B shows a block diagram of an embodiment of host PC 140. Host PC 140 may be a desktop general-purpose computer system, a portable system, a simplified computer system designed for the specific application described herein, a server, a workstation, a mini-computer, a larger mainframe system, or other computing systems.

As shown in FIG. 2B, host PC 140 includes a processor 240 that communicates with a number of peripheral devices via a bus 242. These peripheral devices typically include a memory subsystem 244, a user input subsystem 246, a display subsystem 248, a file storage system 252, and output devices such as printer 170. Memory subsystem 244 may include a number of memory units, including a non-volatile memory 256 (designated as a ROM) and a volatile memory 258 (designated as a RAM) in which instructions and data may be stored. User input subsystem 246 typically includes a keyboard 262 and may further include a pointing device 264 (e.g., a mouse, a trackball, or the like) and/or other common input device(s) 266. Display subsystem 248 typically includes a display device 268 (e.g., a cathode ray tube (CRT), a liquid crystal display (LCD), or other devices) coupled to a display controller 270. File storage system 252 may include a hard disk 274, a floppy disk 276, other storage devices 278 (such as a CD-ROM drive, a tape drive, or others), or a combination thereof. An optional receiver 288 can also couple to bus 242 and may be used for tracking of host PC 140.

Host PC 140 includes a number of I/O devices that facilitate communication with external devices. For example, a parallel port 254 interfaces with printer 170. Network connections are usually established through a device such as a network adapter 282 coupled to bus 242, or a modem 284 via a serial port 286. Host PC 140 can interface with metering device 150 via, for example, parallel port 254 or serial port 286. Other interfaces (e.g., for infrared and wireline devices) can also be provided for host PC 140.

With the exception of the input devices and the display, the other elements need not be located at the same physical site. For example, portions of the file storage system could be coupled via local-area or wide-area network links or telephone lines. Similarly, the input devices and display need not be located at the same site as the processor, although it is anticipated that the present invention will typically be implemented in the context of general-purpose computers and workstations.

The processors and processing units described herein can each be implemented as an application specific integrated circuit (ASIC), a digital signal processor, a microcontroller, a microprocessor, or other electronic units designed to perform the functions described herein. The non-volatile memories can each be implemented with a read only memory (ROM), a FLASH memory, a programmable ROM (PROM), an erasable PROM (EPROM), an electronically erasable PROM (EEPROM), a battery augmented memory (BAM), a battery backed-up RAM (BBRAM), or devices of other memory technologies. The volatile memories can each be implemented with a random access memory (RAM), a FLASH memory, or devices of other memory technologies. Clock 220 is a real-time clock or a secured timer, which is battery backed, to provide accurate time indication even if the metering device is powered down.

As used herein, the term “bus” generically refers to any mechanism for allowing the various elements of the system to communicate with each other. The buses are shown in the figures as a single bus but may include a number of buses. For example, a system typical has a number of buses such as a local bus and one or more expansion buses (e.g., ADB, SCSI, ISA, EISA, MCA, NuBus, or PCI), as well as serial and parallel ports.

The printers can be specially designed printers or conventional printers. The printers are capable of printing human-readable information, machine-readable information, and others. For example, the printers may be directed to print one-dimensional barcodes, two-dimensional barcodes, facing identification mark (FIM) markings, texts, and other graphics. In a specific embodiment, the printers are specially designed printers that are used to print indicia and may be capable of printing other information such as address label, tax stamp, secured ticket, money order, and the like. One such printer is a thermal printer having a resolution of, for example, approximately 200 dots per inch.

In an embodiment of the invention, the position of a metering device is estimated through the use of a Global Position System (GPS) receiver. The GPS receiver receives precisely timed radio frequency (RF) signals from two or more GPS satellites and determines positional estimates based on the received RF signals. Each RF signal includes timing information based on an accurate clock aboard the respective GPS satellite. The position of the metering device can be estimated using, for example, triangulation technique. Specifically, the GPS receiver determines the time-of-arrival of the RF signals, converts the time-of-arrival measurements to range estimates, and computes an estimate of the position of the metering device based on the range estimates. The processing of the RF signals from GPS satellites to determine position is further described in the following patents:

U.S. Pat. No. 5,621,793 entitled “TV Set Top Box Using GPS,” issued Apr. 15, 1997;

U.S. Pat. No. 5,459,473 entitled “Global Position System Receiver,” issued Oct. 17, 1995;

U.S. Pat. No. 5,379,045 entitled “SATPS Mapping with Angle Orientation Calibration,” issued Jan. 3, 1995;

U.S. Pat. No. 5,359,332 entitled “Determination of Phase Ambiguities in Satellite Ranges,” issued Oct. 25, 1994;

U.S. Pat. No. 5,101,416 entitled “Multi-Channel Digital Receiver for Global Positioning System,” issued Mar. 31, 1992; and

U.S. Pat. No. 4,807,256 entitled “Global Position System Receiver,” issued Feb. 21, 1989.

All of the above patents are incorporated herein by reference and are collectively referred to herein as the “GPS patents.”

Typically, RF signals from three satellites at three different positions are used to determine a three dimensional position of the metering device. However, timing errors introduced by imperfect synchronization of the receiver timing with the satellites' precise timing can cause corresponding errors in the estimated position. Thus, a fourth GPS satellite at a fourth position is sometimes used to provide a fourth measurement that is used to factor out the timing error.

In another embodiment of the invention, the position of a metering device is estimated through the use of a cellular receiver. The cellular receiver can operate at either the cellular band (e.g., 900 MHz), the personal communication system (PCS) band (e.g., 1.8 GHz), or some other frequency bands. The cellular receiver receives signal transmissions from two or more transmitting cell sites or base stations. The receiver then uses the timing information from these signals to estimate position in a manner (e.g., using triangulation technique) similar to that for the GPS signals. A cellular system that can be used in conjunction with the invention is described in U.S. Pat. No. 5,103,459, entitled “System and Method for Generating Signal Waveforms in a CDMA Cellular Telephone System,” issued Apr. 7, 1992, and incorporated herein by reference.

Specifically, each transmitting base station is located at a fixed position and transmits using a code that uniquely identifies that base station to the receiving unit. The transmitting base stations are also synchronized using an accurate timing source (e.g., from a GPS satellite). By receiving the signals from two or more transmitting base stations, the position of the metering device can be estimated using similar calculations as for GPS satellites.

In yet another embodiment of the invention, the position of a metering device is estimated through the use of a terrestrial receiver. Numerous wireless networks are currently available for various applications. For example, one conventional wireless network has been designed to collect information from electric meters. This network includes a number of transceivers located, for example, on telephone poles. This network can also be adapted to collect positional information for metering devices. For example, a transmitter located on the metering device can (e.g., periodically) transmit a signal to the transceivers that receive and process the signals to estimate the position of the metering device. Alternatively, the transceivers can transmit signals that are received and processed by the metering device to estimate position.

The positional information on the metering device can be used in numerous manners. In an embodiment, the metering device is authorized for operation within a designated geographic area. Periodically, or upon receiving a command from a service center (e.g., via the central processing system), the metering device estimates it position. The metering device then compares the estimated position to the designated geographic area to determine whether it is located within its designated geographic area. Alternatively, the meter can send the GPS data to the service center that then determines whether the meter is operating within the designated geographic area.

Numerous actions can be taken in response to the positional information. In an embodiment, the meter is disabled upon a determination that it is located outside its designated geographic area. The metering device can render itself inoperable on its own, or can be disabled by a command from the service center. In another embodiment, the position of the metering device is made available to the service center that then sends a factory technician to retrieve the device. In yet another embodiment, a set of operations by the metering device is disabled upon a determination that it is located outside its designated geographic area. For example, operations that can modify the accounting registers used to store values can be disabled. Similarly, postage printing can also be disabled.

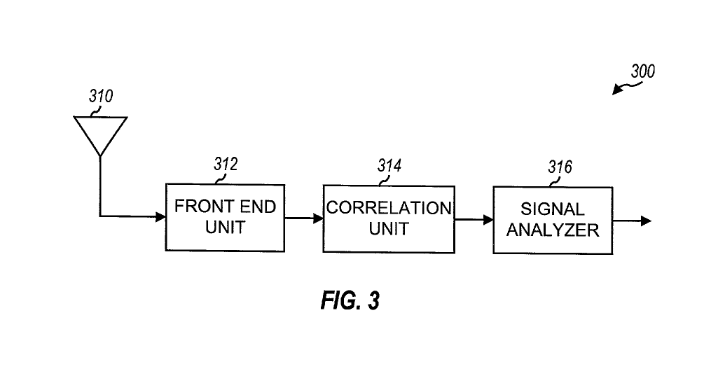

FIG. 3 shows a block diagram of an embodiment of a receiver 300 that can be used to estimate the position of a device. Receiver 300 can be coupled to, or disposed within, either metering device 150 or host PC 140, or both. The RF signals from transmitting sources (e.g., the GPS satellites) are received by an antenna 310 and provided to a front-end unit 312. Front-end unit 312 amplifies and filters the RF signals, downconverts the signals to baseband or a suitable intermediate frequency (IF), and digitizes the downconverted signal. The digitized data is then provided to a correlation unit 314.

For GPS, each GPS satellite transmits data that is spectrally spread with a unique Gold code assigned to that GPS satellite. Through the Gold codes, a GPS receiver is able to determine the source of a particular RF signal.

In an embodiment, within correlation unit 314, the digitized data is correlated with an internally generated code sequence. This internally generated sequence can correspond to the Gold code of the GPS satellite whose range is being estimated. The internally generated sequence is shifted in time until the correlation between the received signal and the internally generated sequence is maximized. Correlation unit 314 then provides the timing alignment information to a signal analyzer 316. Signal analyzer 316 converts the time alignment information to a range estimate using, for example, radio wave propagating velocity. The range estimates of two or more GPS satellites are then used to estimate the position of the metering device. Determination of the range estimates and position in a GPS system is further disclosed in the aforementioned GPS patents.

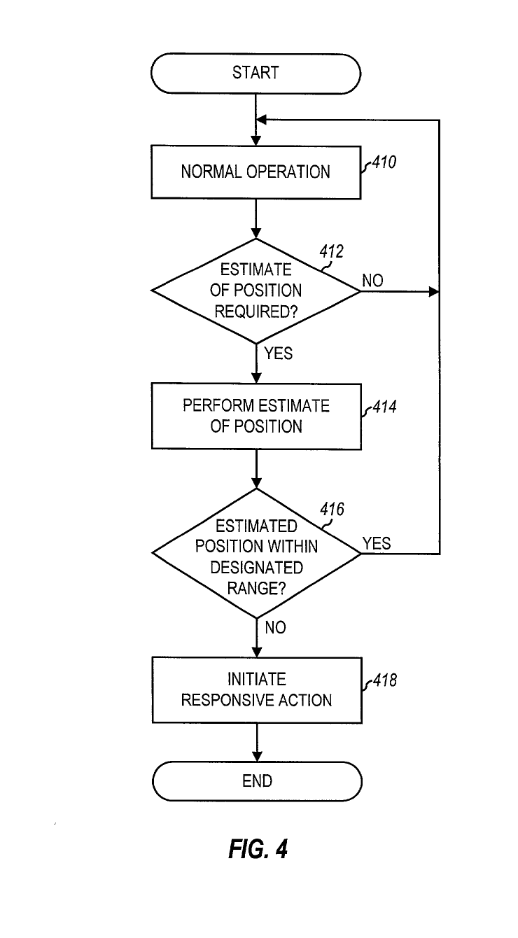

FIG. 4 shows a flow diagram of an embodiment of a postage metering process that employs positional information. Initially, the metering device operates in a normal manner, at step 410. At step 412, a determination is made whether an estimate of the position of the metering device is required. The positional estimate can be requested (e.g., periodically) by the service center as part of a position-based security system. The positional estimate can also be requested as necessary by the metering device or the host PC, for example, as part of a fraud detection and prevention scheme. If positional information is not required, the process returns to step 410. Otherwise, the process proceeds to step 414 in which the position of the metering device is estimated.

At step 416, a determination is made whether the estimated position of the metering device is within a designated geographic area. If the answer is yes, the process returns to step 410. Otherwise, the process proceeds to step 418 in which one or more appropriate responsive actions are initiated. For example, the entire meter or a subset of meter operations can be disabled.

The positional information can be used for security and other applications. For example, the positional information can be used to assist the service center (or other interested entities) in determining the whereabouts of the metering devices within its control. The positional information can also be used to retrieve a metering device that has been displaced (e.g., accidentally, intentionally, or fraudulently). The positional information can also be used for business plans (e.g., to decide how to effectively provide support services based on the distribution of the meters). The positional information can also be used in many other applications.

Also, although the above discusses estimation of the position of the metering device, the same discussion generally applies to estimation of the position of the host PC. Furthermore, the positional information of the host PC can be used in the various manners described above for the meter.

The invention has been described for postage metering systems, but is equally applicable for postage printing systems, and other systems.

The foregoing description of the specific embodiments is provided to enable any person skilled in the art to make or use the present invention. Various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A metering device comprising:
a memory configured to hold data indicative of a designated geographic area;
a receiver configured to receive and process signals from a plurality of transmitting sources to provide an estimate of a position of the metering device; and
a processor operatively coupled to the memory and metering device, the processor configured to receive data from the memory and the estimated position from the receiver and to determine whether the metering device is located within the designated geographic area.

2. The metering device of claim 1, wherein the processor initiates a responsive action based on the estimated position of the metering device.

3. The metering device of claim 2, wherein the responsive action includes disabling a set of operations of the metering device.

4. The metering device of claim 2, wherein the responsive action is initiated by a service center that operatively couples to the metering device.

5. The metering device of claim 2, wherein the responsive action is self initiated by the metering device.

6. The metering device of claim 1, wherein the transmitting sources comprise Global Position System (GPS) satellites.

7. The metering device of claim 1, wherein the transmitting sources comprise cellular base stations.

8. The metering device of claim 1, wherein the signals are received from at least three transmitting sources.

9. A metering device comprising:
a receiver configured to receive and process signals from a plurality of Global Position System (GPS) satellites to provide positional information indicative of an estimated position of the metering device; and
a processor operatively coupled to the receiver, the processor configured to receive the positional information and initiate a responsive action based on the received positional information.

10. The metering device of claim 9, wherein the metering device disables a set of operations based on the positional information.

11. The metering device of claim 9, wherein the signals are received from at least three GPS satellites.

12. A method for providing security in a postage metering system using positional information, wherein the postage metering system includes a metering device, the method comprising:
determining a designated geographic area for a metering device;
receiving signals, at the metering device, from a plurality of transmitting sources;
processing the received signals to provide an estimate of a position of the metering device;
determining whether the estimated position of the metering device is within the designated geographic area; and
initiating a responsive action based on the estimated position of the metering device.

13. The method of claim 12, wherein the transmitting sources include Global Position System (GPS) satellites.

14. The method of claim 12, wherein the transmitting sources include cellular base stations.

15. The method of claim 12, wherein the signals are received from at least three transmitting sources.

16. The method of claim 12, wherein the initiating includes
disabling a set of operations of the metering device based on the estimated position.

17. In a postage metering system, a method for providing functions based on positional information comprising:
receiving signals, at a metering device, from a plurality of Global Position System (GPS) satellites;
processing the received signals to provide positional information indicative of an estimated position of the metering device; and
initiating an action responsive to the positional information.

18. The method of claim 17, further comprising:
disabling a set of operations of the metering device based on the positional information.

19. The method of claim 17, wherein the signals are received from at least three GPS satellites.
